(19) United States
(12) Patent Application Publication
(10) Pub. No.: US 2011/0246672 A1
(43) Pub. Date: Oct. 6, 2011

(54) CONTENTS PROVIDING SYSTEM, INFORMATION PROCESSING DEVICE, CONTENTS PROVIDING METHOD, PROGRAM AND COMPUTER READABLE RECORDING MEDIA

(75) Inventors: Hideki Matsuda, Fujimi-machi (JP); Hidetsugu Obi, Matsumoto-shi (JP)

(73) Assignee: Seiko Epson Corporation, Tokyo (JP)

(21) Appl. No.: 13/042,891

(22) Filed: Mar. 8, 2011

(30) Foreign Application Priority Data
Apr. 2, 2010 (JP) 2010-086470

(51) Int. Cl. G06F 15/16

(52) U.S. Cl. 709/246

(57) ABSTRACT

A contents providing system provides contents and associated data corresponding to the contents to a plurality of information processing devices. The contents providing system is equipped with a transfer control section that executes a control as to whether a change made to first associated data stored in a first information processing device corresponding to a set of contents is to be transferred from the first information processing device to a second information processing device that stores second associated data corresponding to the set of contents, and the transfer control section executes the control when a specified event occurs.

### BACKGROUND

1. Technical Field

The present invention relates to contents providing systems, information processing devices, contents providing methods, programs and computer readable recording media.

2. Related Art

There is a published technology for remotely accessing recorded contents stored in a transponder, and creating annotation data for the recorded contents and stores the created annotation data in the transponder without changing the recorded contents (see, for example, JP-A-2004-118836 (Patent Document 1)).

However, the aforementioned technology places a heavy load on a communications network with its data communications.

### SUMMARY

In accordance with some aspects of the invention, contents providing systems, information processing devices, contents providing methods, programs and computer readable recording media, which enable data communications without placing a large load to a communications network, are provided.

A contents providing system in accordance with an embodiment of the invention pertains to a contents providing system that provides contents and associated data corresponding to the contents to a plurality of information processing devices. The contents providing system includes a transfer control section that executes a control as to whether a change made to first associated data stored in a first information processing device corresponding to a set of contents is to be transferred from the first information processing device to a second information processing device that stores second associated data corresponding to the set of contents, and the transfer control section executes the control when a specified event occurs. According to the embodiment, when the first associated data stored in the first information processing device and the second associated data stored in the second information processing device are mutually synchronized, data to be transferred between the first information processing device and the second information processing device can be suppressed to a small amount.

The contents providing system in accordance with an aspect of the invention further includes a judging section that executes a judgment as to whether or not the change has been transferred to the second information processing device. When the judging section judges that the change has not been transferred to the second information processing device, the transfer control section may execute the control so as to transfer the change. According to this structure, even when three or more information processing devices share associated data, the associated data can be shared while data to be transferred can be suppressed to a small amount.

In the contents providing system in accordance with an aspect of the invention, the transfer control section may execute the control so as to transfer the change when the set of contents satisfies a specified condition, and may execute the control so as not to transfer the change when the set of contents does not satisfy the specified condition. According to such a structure, unnecessary data transfer can be prevented, and therefore data to be transferred can be suppressed to a small amount.

An information processing device in accordance with another embodiment of the invention pertains to an information processing device capable of communications with another information processing device and capable of storing contents and associated data corresponding to the contents. The information processing device includes a transfer control section that executes a control as to whether a change made to first associated data stored in a first information processing device corresponding to a set of contents is to be transferred from the first information processing device to a second information processing device that stores second associated data corresponding to the set of contents, and the transfer control section executes the control when a specified event occurs. According to the embodiment, when the first associated data stored in the first information processing device and the second associated data stored in the second information processing device are mutually synchronized, data to be transferred between the first information processing device and the second information processing device can be suppressed to a small amount.

The information processing device in accordance with an aspect of the invention further includes a judging section that executes a judgment as to whether or not the change has been transferred to the second information processing device. When the judging section judges that the change has not been transferred to the second information processing device, the transfer control section may execute the control so as to transfer the change. According to this structure, even when three or more information processing devices share associated data, the associated data can be shared while data to be transferred can be suppressed to a small amount.

In the information processing device in accordance with an aspect of the invention, the transfer control section may execute the control so as to transfer the change when the set of contents satisfies a specified condition, and may execute the control so as not to transfer the change when the set of contents does not satisfy the specified condition. According to such a structure, unnecessary data transfer can be prevented, and therefore data to be transferred can be suppressed to a small amount.

An information processing device in accordance with still another embodiment of the invention pertains to an information processing device capable of communications with another information processing device and capable of storing contents and associated data corresponding to the contents. The information processing device includes an update section that makes a change to first associated data corresponding to a set of contents stored, a transfer control section that controls transfer of the change to the other information processing device that stores second associated data corresponding to the set of contents, and a transmission section that transmits the change to the other information processing device, and the transfer control section instructs the transmission section to transfer the change when a specified event occurs. According to the embodiment, when the first associated data stored in the information processing device and the second associated data stored in the other information processing device are mutually synchronized, data to be transferred between the information processing device and the other information processing device can be suppressed to a small amount.

The information processing device in accordance with an aspect of the invention further includes a judging section that executes a judgment as to whether or not the change has been transferred to the other information processing device. When the judging section judges that the change has not been transferred to the other information processing device, the transfer control section may instruct the transmission section to transfer the change. According to this structure, even when three or more information processing devices share associated data, the associated data can be shared while data to be transferred can be suppressed to a small amount.

The information processing device in accordance with an aspect of the invention may be structured such that the transfer control section instructs the transmission section to transfer the change when the set of contents satisfies a specified condition, and the transfer control section does not instruct the transmission section to transfer the change when the set of contents does not satisfy the specified condition. According to such a structure, unnecessary data transfer can be prevented, and therefore data to be transferred can be suppressed to a small amount.

A contents providing method in accordance with another embodiment of the invention pertains to a contents providing method that provides contents and associated data corresponding to the contents to a plurality of information processing devices. The contents providing method includes a transfer step of transferring a change made to first associated data stored in a first information processing device corresponding to a set of contents from the first information processing device to a second information processing device that stores second associated data corresponding to the set of contents, and the transfer step is executed when a specified event occurs. According to the embodiment, when the first associated data stored in the first information processing device and the second associated data stored in the second information processing device are mutually synchronized, data to be transferred between the first information processing device and the second information processing device can be suppressed to a small amount.

The contents providing method in accordance with an aspect of the invention further includes a judging step of judging as to whether or not the change has been transferred to the second information processing device. When it is judged in the judging step that the change has not been transferred to the second information processing device, the transfer step may be executed. According to this structure, even when three or more information processing devices share associated data, the associated data can be shared while data to be transferred can be suppressed to a small amount.

The contents providing method in accordance with an aspect of the invention may be structured such that the transfer step is executed when the set of contents satisfies a specified condition, and the transfer step is not executed when the set of contents does not satisfy the specified condition. According to such a structure, unnecessary data transfer can be prevented, and therefore data to be transferred can be suppressed to a small amount.

A program in accordance with an embodiment of the invention renders a computer, in a first information processing device, to function as a transfer control section that executes a control as to whether a change made to first associated data stored in the first information processing device corresponding to a set of contents is to be transferred from the first information processing device to a second information processing device that stores second associated data corresponding to the set of contents, when a specified event occurs. According to the embodiment, when the first associated data stored in the first information processing device and the second associated data stored in the second information processing device are mutually synchronized, data to be transferred between the first information processing device and the second information processing device can be suppressed to a small amount.

A program in accordance with another embodiment of the invention renders a computer to function as an update section that makes a change to first associated data corresponding to a set of contents, a transmission section that transmits the change to another information processing device that stores second associated data corresponding to the set of contents, and a transfer control section that instructs the transmission section to transfer the change when a specified event occurs. According to the embodiment, when the first associated data stored in one information processing device and the second associated data stored in another information processing device are mutually synchronized, data to be transferred between the information processing device and the other information processing device can be suppressed to a small amount.

In accordance with yet another embodiment of the invention, a program that renders a computer, in a first information processing device, to function as a transfer control section that executes a control as to whether a change made to first associated data stored in the first information processing device corresponding to a set of contents is to be transferred from the first information processing device to a second information processing device that stores second associated data corresponding to the set of contents when a specified event occurs, is stored in a computer-readable manner. According to the embodiment, when the first associated data stored in the first information processing device and the second associated data stored in the second information processing device are mutually synchronized, data to be transferred between the first information processing device and the second information processing device can be suppressed to a small amount.

In accordance with still another embodiment of the invention, a program that renders a computer to function as an update section that makes a change to first associated data corresponding to a set of contents, a transmission section that transmits the change to another information processing device that stores second associated data corresponding to the set of contents, and a transfer control section that instructs the transmission section to transfer the change when a specified event occurs is stored in a computer-readably manner. According to the embodiment, when the first associated data stored in one information processing device and the second associated data stored in another information processing device are mutually synchronized, data to be transferred between the information processing device and the other information processing device can be suppressed to a small amount.

### BRIEF DESCRIPTION OF THE DRAWINGS

FIG. 1 shows an example of a contents providing system 10 in accordance with a first embodiment of the invention.

FIG. 2 shows a flow chart of an example of a processing procedure by the contents providing system 10.

FIG. 3 shows an example of a functional composition of the contents providing system 10.

FIG. 4 shows an example of a contents providing system 20 in accordance with a second embodiment of the invention.

FIG. 5 shows a flow chart of an example of a processing procedure by the contents providing system 20.

FIG. 6 shows a flow chart of another example of a processing procedure by the contents providing system 20.

FIG. 7 shows an example of a functional composition of the contents providing system 20.

FIG. 8 shows an example of data stored in the contents providing system 20.

FIG. 9 shows an example of a hardware composition.

### DESCRIPTION OF EXEMPLARY EMBODIMENTS

Preferred embodiments of the invention are described below with reference to the accompanying drawings.

### First Embodiment

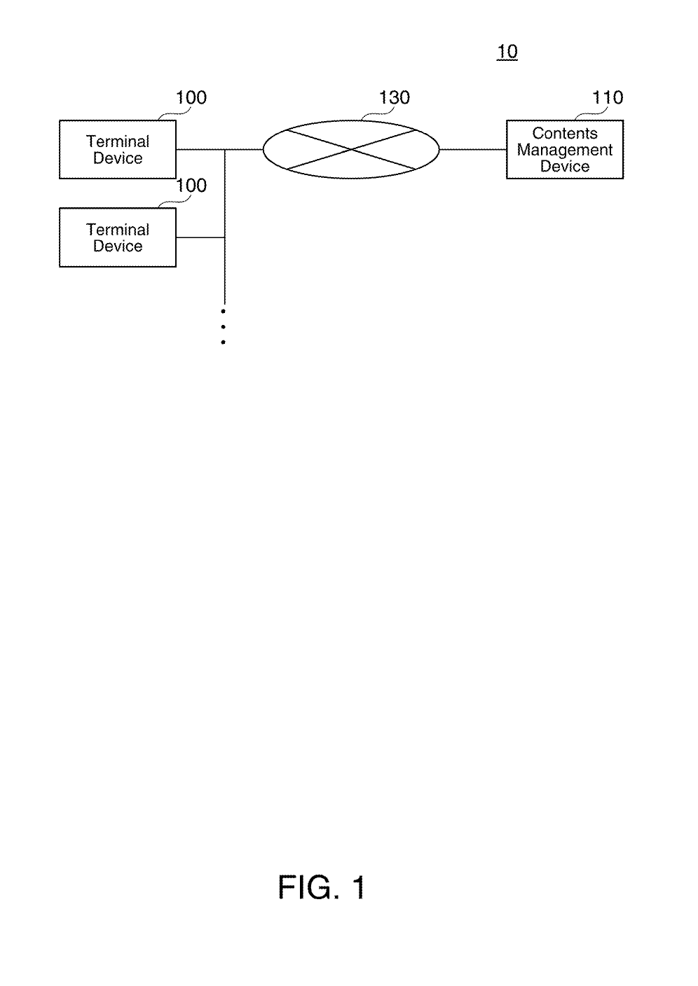

FIG. 1 shows an example of a contents providing system 10 in accordance with a first embodiment of the invention. The contents providing system 10 is equipped with terminal devices 100 and a contents management device 110. The contents providing system 10 is a system that provides contents and associated data of the contents to the terminal devices 100.

The terminal device 100 is an information processing device that handles contents, such as, a PDA (Personal Digital Assistant), a portable telephone, a personal computer or the like. As an example of the terminal device 100, an electronic book that handles PDF data as contents may be enumerated. The contents management device 110 is an information processing device, such as, a personal computer or the like.

The contents management device 110 may be a first information processing device, and the terminal device 100 may be a second information processing device. The contents management device 110 may be defined as the second information processing device, and the terminal device 100 may be defined as the first information processing device. The contents management device 110 is another information processing device as viewed from the terminal device 100. Each of the terminal devices 100 is another information processing device as viewed from the contents management device 110.

The terminal devices 100 and the contents management device 110 are connected to a communications network 130, such as, the Internet, LAN, Wi-Fi, a fixed telephone network, a portable telephone network or the like. Contents, associated data and various control data are transferred between the terminal devices 100 and the contents management device 110. The terminal devices 100 and the contents management device 110 may be mutually connected through other wired communications or wireless communications, without using the communications network 130.

Contents may be document data, photograph data, music data, image data, and data that combine the forgoing data. For example, as an example of contents, PDF data may be enumerated. Associated data may be information correlated with contents, and may be data relating to the contents. When contents are PDF data, an example of associated data may be annotation data written to the PDF data by the user. The contents providing system 10 can transfer the associated data between the terminal device 100 and the contents management device 110, independently of the contents. The associated data may be stored in a file different from a file that stores the contents, or may be recorded in the same file that stores the contents. Also, the associated data may be composed of a plurality of files.

The contents management device 110 stores a plurality of contents and a plurality of associated data in a database. More specifically, a plurality of contents and a plurality of associated data are stored in a second storage section 250. Also, the contents management device 110 manages the plurality of contents and the plurality of associated data stored in the database. For example, the contents management device 110 retrieves contents and associated data from the database according to a request from the terminal device 100. Then, a second transmission section 258 of the contents management device 110 transmits the retrieved contents and associated data to the terminal device 100. A second acquisition section 260 of the contents management device 110 obtains contents or associated data transmitted from the terminal device 100, and may store the obtained contents or the obtained associated data in the database. It is noted that the database may be included in the contents management device 110, or may be included in an external information processing device connected to the contents management device 110.

On the other hand, the terminal device 100 obtains contents and associated data from the contents management device 110, and obtained contents and associated data in a database. The terminal device 100 is capable of reproducing, displaying and editing the contents and associated data obtained from the contents management device 110. It is noted that the database may be included in the terminal device 100 or may be included in an external information processing device connected to the terminal device 100.

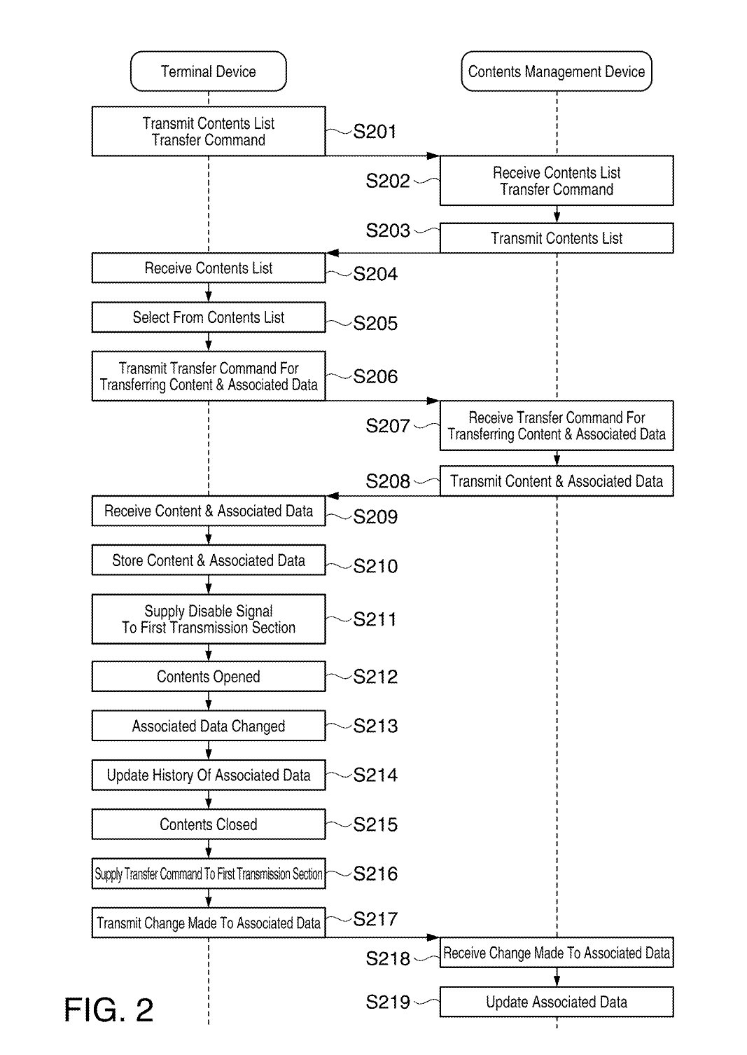

Next, a specific processing procedure by the contents providing system 10 in accordance with the first embodiment, and a specific functional composition of the contents providing system 10 in accordance with the first embodiment will be described. First, referring to FIG. 2, the processing procedure by the contents providing system 10 in accordance with the first embodiment will be described. FIG. 2 shows an example of a processing procedure performed by the contents providing system 10.

First, a first transmission section 208 of the terminal device 100 transmits, to the contents management device 110, a transfer command for transferring a list of a plurality of contents stored in the second storage section 250 of the contents management device 110 (hereafter referred to as a “contents list of the contents management device 110”) to the terminal device 100 (step S201).

At the contents management device 110, the second acquisition section 260 receives the transfer command transmitted by the terminal device 100 (step S202). In response to the command, a second contents list transmission section 254 transmits the contents list of the contents management device 110 to the terminal device 100 (step S203).

At the terminal device 100, a first acquisition section 210 receives the contents list of the contents management device 110 transmitted from the contents management device 110 (step S204). When one of the contents is selected from the contents list of the contents management device 110 received (step S205), the first transmission section 208 transmits, to the contents management device 110, a transfer command for transferring the selected content and associated data of the content to the terminal device 100 (step S206).

At the contents management device 110, the second acquisition section 260 receives the transfer command transmitted by the terminal 100 (step S207). In response to the command, the second transmission section 258 transmits the content and the associated data of the content to the terminal device 100 according to the received transfer command (step S208).

At the terminal device 100, the first acquisition section 210 receives the content and the associated data of the content transmitted from the contents management device 110 (step S209), and stores the received content and its associated data in a first storage section 200 (step S210). Further, a transfer control section 278 supplies a disable signal to the first transmission section 208 such that, even when a change is made to the associated data of the content afterward, the change is not to be transferred to the contents management device 110 (step S211).

Then, when the content stored in the step S210 is opened by the user of the terminal device 100 (step S212), and the associated data thereof is updated by a first update section 202 (step S213), the change is not transferred to the contents management device 110 at this moment, and an update history of the associated data is created or updated (step S214).

Then, when an event of closing the content opened by the user of the terminal device 100 occurs (step S215), the transfer control section 278 that has received the event supplies, to the first transmission section 208, a transfer command for transferring the change made to the associated data to the contents management device 110 (step S216).

The first transmission section 208 that has received the transfer command transfers, to the contents management device 110, any changes among changes made to the associated data of the content at the terminal device 100 which have not been transferred to the contents management device 110 (step S217). Here, in the update history of the associated data, flags may be set to the changes that have been transferred to the contents management device 110. By so doing, by referring to the update history of the associated data at the time of the next transfer, changes that have not been transferred to the contents management device 110 can be readily identified.

At the contents management device 110, the second acquisition section 260 receives the change made to the associated data transferred from the terminal device 100 (step S218), and a second automatic update section 262 makes the change received from the terminal device 100 to the associated data stored in the second storage section 250 (step S219).

Then, the terminal device 100 may return the processing between the step S210 and the step S211, and may wait for a further change to be made to the associated data of the content. If a further change to the associated data of the content occurs, the processings in the step S214, the step S215, the step S216 and then the step S217 are performed. In the step S217, by referring to the update history of the associated data, the change that has not been transferred to the contents management device 110, in other words, the further change made to the associated data can be identified. Then, only the further change made to the associated data is transferred to the contents management device 110.

According to the embodiment of the invention described above, when the associated data of the contents are synchronized between the contents management device 110 and the terminal device 100, only the change newly made to the associated data at the terminal device 100 is transferred from the terminal device 100 to the contents management device 110, so that the amount of data to be transferred between the contents management device 110 and the terminal device 100 can be suppressed to a minimum level.

The processing procedure shown in FIG. 2 is an example in which, at the terminal device 110, changes are made to associated data of a document (contents) that are stored in the contents management device 110 but not stored in the terminal device 100, and after the document has been closed, the changes made to the associated data are transferred together from the terminal device 100 to the contents management device 110. This is however only an example. For example, when contents and their associated data are already stored in the terminal device 100, the steps S201 through S210 are not necessary. Also, the document may be maintained in an opened state, and each time a change is made to the associated data in the step S213, the steps S214, S216 and S217 may be executed. Alternatively, regardless of whether the document is opened or not, the step S216 and the step S217 may be executed when an instruction by the user of the terminal device 100 is received. Also, the step S214, the step S216 and the step S217 may be automatically executed at the timing when a specified event occurs. The specified event may be an event when the terminal device 100 is connected to the communications network 130, when the user of the terminal device 100 closes a document, when the terminal device 100 is disconnected from the communications network 130, when an instruction is received from the user of the terminal device 100 or the user of the contents management device 110, and the like. Moreover, the system can be configured such that, only when parameters, such as, the file name, the file type, the storage directory, the creation date and the like of contents corresponding to the associated data to which changes are made coincide with predetermined conditions, details of the changes made to the associated data are transferred from the terminal device 100 to the contents management device 110.

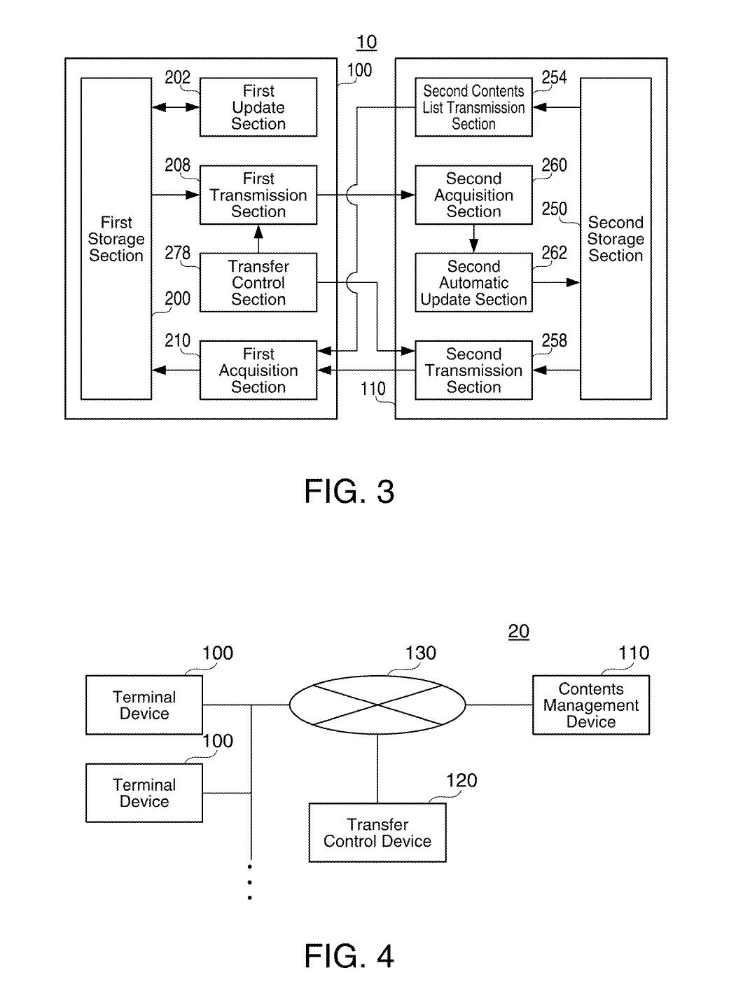

Next, referring to FIG. 3, various functions of the terminal device 100 and the contents management device 110 used for executing the processings described above are described in detail. First, the functions of the terminal device 100 and the contents management device 110 for transferring details of changes made to associated data are described.

FIG. 3 shows an example of a functional composition of the contents providing system 10. The terminal device 100 is equipped with a first storage section 200, a first update section 202, a first transmission section 208, a first acquisition section 210 and a transfer control section 278.

The first storage section 200 stores a plurality of contents. Also, the first storage section 200 stores associated data of contents correlated to the contents, for each of the plurality of contents. The first storage section 200 also stores a list of contents indicative of the plurality of contents stored in the first storage section 200 (hereafter referred to as a “contents list of the terminal device 100”). Also, the first storage section 200 stores an update history of the associated data stored in the first storage section 200.

The terminal device 100 can create a contents list of the terminal device 100 by referring to the first storage section 200. The contents list of the terminal device 100 is stored in the first storage section 200. Also, the terminal device 100 is capable of updating the contents list of the terminal device 100 stored in the first storage section 200 to the latest state by referring to the first storage section 200 periodically or at timings when predetermined events occur.

The first update section 202 updates the associated data stored in the first storage section 200. For example, the terminal device 100 displays the contents list of the terminal device 100 stored in the first storage section 200 on a display device, and accepts a selection operation by an input device to select desired contents. Then, the terminal device 100 retrieves the selected contents from the first storage section 200, and displays the retrieved contents on the display device. Then, the first update section 202 accepts a change operation by the input device to change associated data of the contents, and decides a change to be made to the associated data. Then, the first update section 202 makes the decided change to the associated data stored in the first storage section 200, thereby updating the associated data stored in the first storage section 200. Furthermore, the first update section 202 stores an update history of the updated associated data in the first storage section 200.

The first transmission section 208 transmits the detail of the change made to the associated data. For example, the first transmission section 208 transmits the detail of the change to the contents management device 110 in response to a transfer command to transfer the detail of the change made to the associated data sent from the transfer control section 278. Changes made to the associated data are stored in the update history of the associated data, such that, by referring to the update history of the associated data stored in the first storage section 200, the first transmission section 208 can identify changes recently made to the associated data. By setting flags to those of the changes that have already been transmitted to the contents management device 110, the first transmission section 208 can specify changes that have not been transmitted to the contents management device 110. Thus, the first transmission section 208 can transmit, to the contents management device 110, any changes among the changes recently made to the associated data which have not been transmitted to the contents management device 110.

The transfer control section 278 controls transfer of various data between the terminal device 100 and the contents management device 110. For example, the transfer control section 278 controls transfer of changes added to the associated data from the terminal device 100 to the contents management device 110.

For example, the transfer control section 278, in the terminal device 100, executes a control as to whether a change made to first associated data stored in the terminal device 100 corresponding to a set of contents is to be transferred from the terminal device 100 to the contents management device 110 that stores second associated data corresponding to the set of contents. The transfer control section 278 executes the control when a specified event occurs. The specified event mentioned here may be an event when, for example, the terminal device 100 is connected to the communications network 130, when the user of the terminal device 100 closes a document, when the terminal device 100 is disconnected from the communications network 130, when an instruction is received from the user of the terminal device 100 or the user of the contents management device 110, and the like, as described above with reference to FIG. 2, without any particular limitation to the foregoing event.

Moreover, the transfer control section 278 may be configured to execute the control described above such that the change is transferred only when a set of contents satisfies a specified condition, or may be configured to execute the control described above such that the change is not transferred when a set of contents does not satisfy the specified condition. More specifically, the transfer control section 278 may instruct the first transmission section 208 to transfer the change when a set of contents satisfies a specified condition, and may instruct the first transmission section 208 not to transfer the change when a set of contents does not satisfy the specified condition. For example, only when parameters, such as, the file name, the file type, the storage directory, the creation date and the like of the contents corresponding to the associated data to which the change is made coincide with a predetermined condition, the transfer control section 278 may execute the control described above such that the change made to the associated data is transferred from the terminal device 100 to the contents management device 110.

The contents providing system 10 in accordance with the first embodiment may further be equipped with a judging section that judges as to whether or not changes to the associated data have been transferred to the contents management device 110. In this case, when the judging section judges that any change to the associated data has not been transferred to the contents management device 110, the transfer control section 278 may control to transfer the change made to the associated data. More specifically, in this case, when the judging section judges that a change made to the associated data has not been transferred to the contents management device 110, the transfer control section 278 may instruct the first transmission section 208 to transfer the change made to the associated data. For example, the judging section may judge as to whether the change made to the associated data has been transferred to the contents management device 110 according to transmission completed flags or transmission uncompleted flags correlated to changes made to the associated data, but other methods may be used to judge as to whether or not changes to the associated data have been transferred to the contents management device 110.

The contents management device 110 is equipped with a second storage section 250, a second contents list transmission section 254, a second transmission section 258, a second acquisition section 260, and a second automatic update section 262.

The second storage section 250 stores a plurality of contents. Also, the second storage section 250 stores associated data of contents correlated to the contents, for each of the plurality of contents. Also, the second storage section 250 stores a list of contents indicative of the plurality of contents stored in the second storage section 250 (hereafter referred to as a “contents list of the contents management device 110”). Also, the second storage section 250 stores an update history of the associated data stored in the second storage section 250.

The contents management device 110 can create a contents list of the contents management device 110 by referring to the second storage section 250, and stores the contents list of the contents management device 110 in the second storage section 250. Also, the contents management device 110 updates the contents list of the contents management device 110 stored in the second storage section 250 to the latest state by referring to the second storage section 250 periodically or at timings when specified events occur.

The second acquisition section 260 acquires the detail of the change made to the associated data transmitted from, for example, the terminal device 100. The second automatic update section 262 updates associated data stored in the second storage section 250. For example, the second automatic update section 262 adds the detail of the change made to the contents obtained by the second acquisition section 260 to the associated data that are correlated to the contents and stored in the second storage section 250, thereby updating the associated data stored in the second storage section 250.

According to the contents providing system 10 in accordance with the first embodiment, by using the terminal device 100 described above and the contents management device 110, the amount of data to be transferred between the terminal device 100 and the contents management device 110 can be reduced to a smaller level. The functions of the terminal device 100 and the contents management device 110 described above are only an example. What is required according to the embodiment is that the terminal device 100 or the contents management device 110 is configured such that, among changes made to a set of contents at the terminal device 100, portions of the changes that have not been transferred to the contents management device 110 can be selectively transferred to the contents management device 110.

So far, the functions concerning transfer of details of changes made to associated data have been described. However, the terminal device 100 is capable of transmitting not only details of changes made to associated data, but also contents and associated data to the contents management device 110. Also, the contents management device 110 is likewise capable of transmitting contents and associated data to the terminal device 100.

More specifically, the first transmission section 208 of the terminal device 100 is also capable of transmitting contents and associated data to the contents management device 110. For example, the first transmission section 208 retrieves contents and associated data from the first storage device 200, and transmits the retrieved contents and associated data to the contents management device 110. In this case, at the contents management device 110, the second acquisition section 260 receives the contents and associated data transmitted from the terminal device 100, and stores the received contents and associated data in the second storage section 250.

Also, the second transmission section 258 of the contents management device 110 is also capable of transmitting contents and associated data to the terminal device 100. For example, the second transmission section 258 retrieves contents and associated data from the second storage device 250, and transmits the retrieved contents and associated data to the terminal device 100. In this case, at the terminal device 100, the first acquisition section 210 receives the contents and associated data transmitted from the contents management device 110, and stores the received contents and associated data in the first storage section 200.

The transfer control section 278 of the terminal device 100 may control transfer of contents and associated data from the terminal device 100 to the contents management device 110. For example, when contents and associated data that are not stored in the contents management device 110 are stored in the terminal device 100, the transfer control section 278 may have the terminal device 100 transfer the contents and associated data to the contents management device 110. In this case, at the contents management device 110, the second acquisition section 260 also receives the contents and associated data transmitted from the terminal device 100, and stores the received contents and associated data in the second storage section 250. By this, the transfer control section 278 can have the contents management device 110 and the terminal device 100 store the same contents and associated data.

Further, the transfer control section 278 of the terminal device 100 may control transfer of contents and associated data from the contents management device 110 to the terminal device 100. For example, when contents and associated data that are not stored in the terminal device 100 are stored in the contents management device 110, the transfer control section 278 may have the contents management device 110 transfer the contents and associated data to the terminal device 100. In this case, at the terminal device 100, the first acquisition section 210 also receives the contents and associated data transmitted from the contents management device 110, and stores the received contents and associated data in the first storage section 200. By this, the transfer control section 278 can have the contents management device 110 and the terminal device 100 store the same contents and associated data.

Also, the contents management device 110 is capable of transmitting a contents list of the contents management device 110 to the terminal device 100. More specifically, the second contents list transmission section 254 of the contents management device 110 can also transmit the contents list of the contents management device 110 to the terminal device 100. For example, the second contents list transmission section 254 retrieves a contents list of the contents management device 110 from the second storage section 250, and transmits the retrieved contents list of the contents management device 110 to the terminal device 100. In this case, at the terminal device 100, the first acquisition section 210 acquires the contents list of the contents management device 110 transmitted from the contents management device 110. Then, the terminal device 100 may store the obtained contents list of the contents management device 110 in the first storage section 200, present the contents list for viewing by the user, use the contents list for comparison between the contents stored in the terminal device 100 and the contents stored in the contents management device 110.

### Second Embodiment

Next, an example of a contents providing system 20 in accordance with a second embodiment will be described with reference to FIGS. 4 through 9. In the contents providing system 10 in accordance with the first embodiment, the transfer control section 278 for controlling transfer of changes from the terminal device 100 to the contents management device 110 is included in the terminal device 100. However, in the contents providing system 20 in accordance with the second embodiment, a transfer control section 276 for controlling transfer of changes is included in a transfer control device 120. It is noted that description of components of the second embodiment having functions similar to those of the first embodiment may be omitted if appropriate.

FIG. 4 shows an example of the contents providing system 20 in accordance with the second embodiment. The contents providing system 20 is equipped with at least one terminal device 100, a contents management device 110, and a transfer control device 120. The contents providing system 20 is a system that provides contents and associated data of the contents to the terminal device 100, which does not differ from the contents providing system 10 in accordance with the first embodiment, but further includes the transfer control device 120, which is different from the contents providing system 10 in accordance with the first embodiment. The transfer control device 120 is connected to the communications network 130, like the terminal devices 100 and the contents management device 110. The transfer control device 120 may be connected to the terminal devices 100 and the contents management device 110 through other wired communications or wireless communications, without using the communications network 130.

The transfer control device 120 controls transfer of contents or the like between the terminal device 100 and the contents management device 110. For example, the transfer control device 120 controls transmission of contents and associated data to the terminal device 100 to be performed by the contents management device 110, and also controls transmission of contents and associated data to the contents management device 110 to be performed by the terminal device 100.

For example, when contents that are not stored in the terminal device 100 are stored in the contents management device 110, the transfer control device 120 has the contents management device 110 transfer the contents to the terminal device 100. Also, when contents that are not stored in the contents management device 110 are stored in the terminal device 100, the transfer control device 120 has the terminal device 100 transfer the contents to the contents management device 110. By this, the transfer control device 120 can have the contents management device 110 and the terminal device 100 store the same contents.

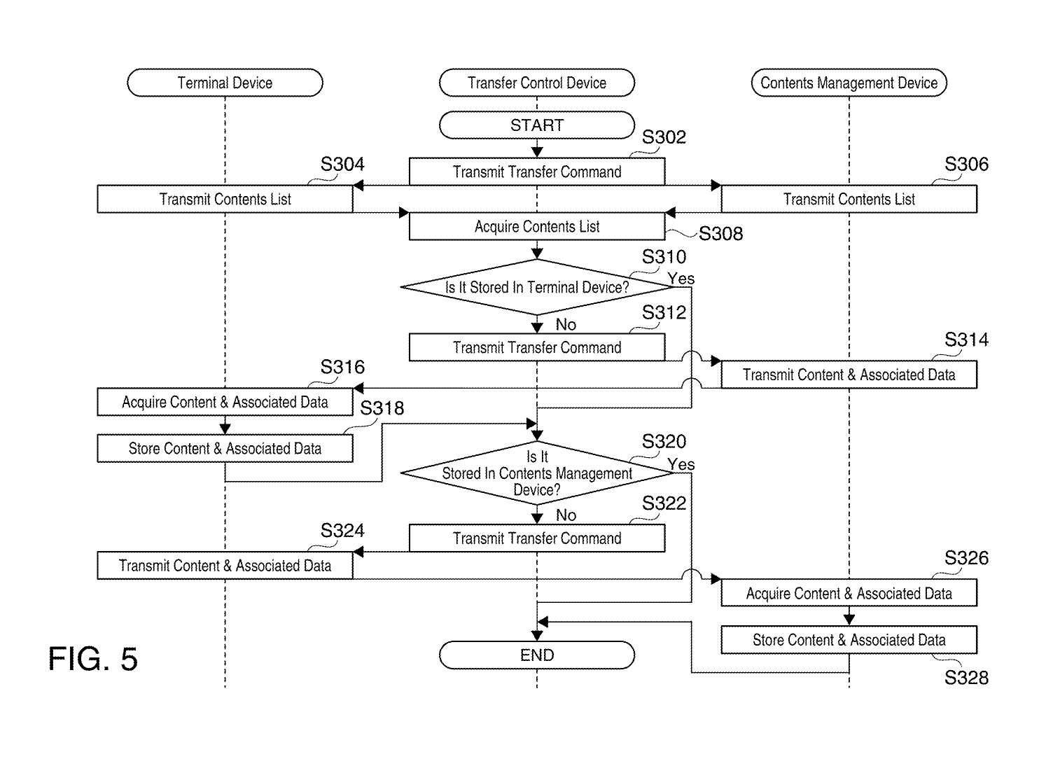

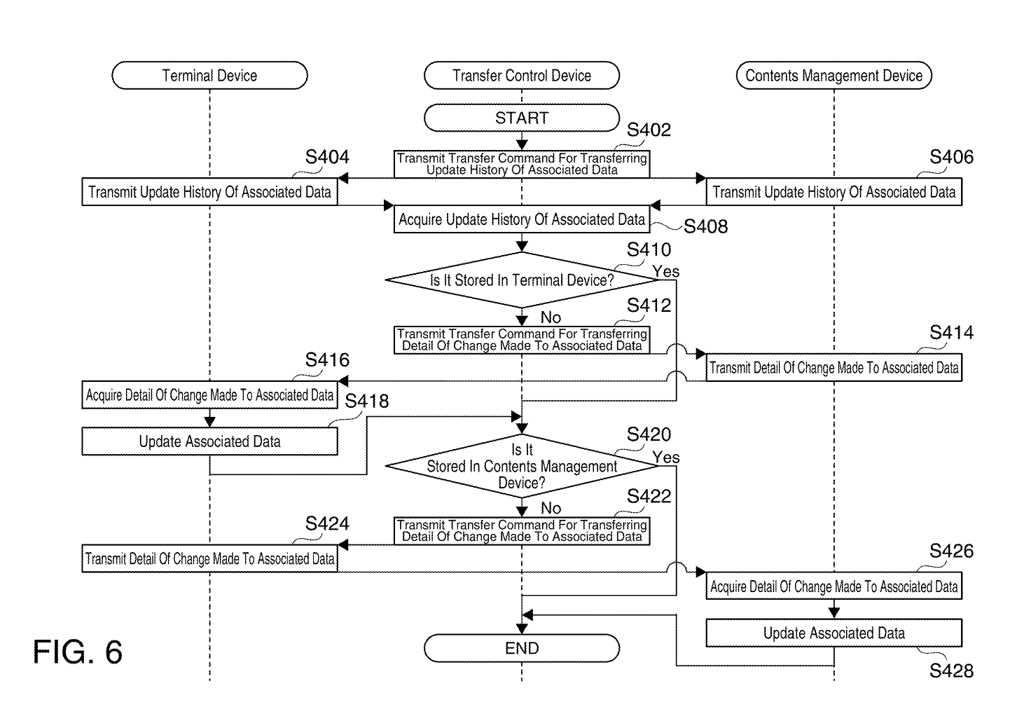

Hereunder, a more specific processing procedure by the contents providing system 10 in accordance with the second embodiment and a more specific functional composition of the contents providing system 20 in accordance with the second embodiment are described. First, referring to FIG. 5 and FIG. 6, the processing procedure performed by the contents providing system 20 in accordance with the second embodiment is described.

FIG. 5 shows an example of the processing procedure by the contents providing system 20. Referring to FIG. 5, an example is described in which, when contents that are stored in the contents management device 110 are not stored in the terminal device 100, the contents that are not stored in the terminal device 100 are transmitted from the contents management device 110 to the terminal device 100, and stored in the terminal device 100. Furthermore, in FIG. 5, an example is also described in which, when contents that are stored in the terminal device 100 are not stored in the contents management device 110, the contents that are not stored in the contents management device 110 are transmitted from the terminal device 100 to the contents management device 110, and stored in the contents management device 110.

First, the contents list acquisition section 270 of the transfer control device 120 transmits, to the terminal device 100 and the contents management device 110, a transfer command for transferring a contents list (step S302). At the terminal device 100 that has acquired the transfer command transmitted in the step S302, the first contents list transmission section 204 transmits the contents list of the terminal device 100 to the transfer control device 120 (step S304).

At the contents management device 110 that has acquired the transfer command transmitted in the step S302, the second contents list transmission section 254 transmits the contents list of the contents management device 110 to the transfer control device 120 (step S306). The contents list acquisition section 270 of the transfer control device 120 acquires the contents list of the terminal device 100 transmitted in the step S304 and the contents list of the contents management device 110 transmitted in the step S306 (step S308).

Next, a judging section 274 of the transfer control device 120 compares the contents list of the terminal device 100 acquired in the step S308 with the contents list of the contents management device 110 acquired in the step S308, and judges as to whether or not contents stored in the contents management device 110 are stored in the terminal device 100 (step S310).

In the step S310, if it is judged that contents stored in the contents management device 110 are not stored in the terminal device 100 (step S310: No), a transfer control section 276 of the transfer control device 120 transmits, to the contents management device 110, a transfer command for transferring contents that are judged as not being stored in the terminal device 100, and a transfer command for transferring associated data of the contents (step S312).

At the contents management device 110 that has acquired the transfer command in the step S312, the second transmission section 258 transmits the contents and the associated data to the terminal device 100 (step S314).

At the terminal device 100, the first acquisition section 210 acquires the contents and the associated data transmitted in the step S314 (step S316). Then, the first storage section 200 stores the contents and the associated data acquired in the step S316 (step S318). Further, the contents providing system 20 advances the processing to step S320. In response to storing the contents and the associated data in the step S318, the terminal device 100 may update the contents list of the terminal device 100 stored in the first storage section to the latest state.

On the other hand, if it is judged that contents stored in the contents management device 110 are stored in the terminal device 100 (step S310: Yes), the contents providing system 20 advances the processing to step S320.

In the step S320, the judging section 274 of the transfer control device 120 compares the contents list of the terminal device 100 acquired in the step S308 with the contents list of the contents management device 110 acquired in the step S308, thereby judging as to whether or not the contents stored in the terminal device 100 are stored in the contents management device 110 (step S320).

In the step S320, if it is judged that the contents stored in the terminal device 100 are not stored in the contents management device 110 (step S320: No), the transfer control section 277 of the transfer control device 120 transmits, to the terminal device 100, a transfer command for transferring the contents that are judged as not being stored in the contents management device 110, and a transfer command for transferring associated data of the contents (step S322).

At the terminal device 100 that has acquired the transfer command transmitted in the step S322, the first transmission section 208 transmits the contents and the associated data to the contents management device 110 (step S324).

In the contents management device 110, the second acquisition section 260 acquires the contents and the associated data transmitted in the step S324 (step S326). Then, the second storage section 250 stores the contents and the associated data acquired in the step S326 (step S328). Then, the contents providing system 20 ends a series of the processings shown in FIG. 5. Here, in response to an event of storing the contents and the associated data in the step S328, the contents management device 110 may update the contents list of the contents management device 110 stored in the second storage section 250 to the latest state.

On the other hand, in the step S320, if it is judged that the contents stored in the terminal device 100 are stored in the contents management device 110 (step S320: Yes), the contents providing system 20 ends a series of the processings shown in FIG. 5.

For example, the contents providing system 20 may perform the processings shown in FIG. 5 upon detecting that the terminal device 100 is connected to the communications network 130, or may periodically perform the processings shown in FIG. 5.

Alternatively, the contents providing system 20 may perform the processings shown in FIG. 5 at the timing when a specified event occurs. The specified event may be, for example, an event when the user of the terminal device 100 gives an instruction to do so, when the user of the terminal device 100 closes a file, when the user of the terminal device 100 logs out, and the like. Also, the processings shown in FIG. 5 may be performed, using a specified event occurring on the side of the contents management device 110 as a trigger. The specified event in this case may be, for example, an event when the user of the contents management device 110 gives an instruction to do so, when the user who is authorized to share associated data at the contents management device 110 logs in, and the like. Also, the processings shown in FIG. 5 may be performed, using a specified event occurring on the side of the transfer control device 120 as a trigger. The specified event in this case may be, for example, an event when the user of the transfer control device 120 gives an instruction to do so, when the user who is authorized to share associated data at the transfer control device 120 logs in, and the like. In addition, the contents providing system 20 may perform the processings shown in FIG. 5 at the timing when an addition, a change or a deletion is made to contents for one of the terminal device 100 and the contents management device 110.

It is noted that the contents providing system 20 may not have to transfer contents from the contents management device 110 to the terminal device 100, when parameters such as the file name, the file type, the storage directory, the creation date and the like of the contents that are judged as not being stored in the terminal device 100 do not coincide with predetermined conditions.

Similarly, the contents providing system 20 may not have to transfer contents from the terminal device 100 to the contents management device 110, when parameters such as the file name, the file type, the storage directory, the creation date and the like of the contents that are judged as not being stored in the contents management device 110 do not coincide with predetermined conditions.

FIG. 6 shows another example of the processing procedure performed by the contents providing system 20. Referring to FIG. 6, an example is described in which, when any change made to the second associated data stored in the contents management device 110 has not been transferred to the terminal device 100, the detail of the change made to the associated data that has not been transferred to the terminal device 100 is transferred from the contents management device 110 to the terminal device 100, and the change is reflected in the first associated data. Furthermore, in FIG. 6, an example is also described in which, when any change made to the first associated data stored in the terminal device 100 has not been transferred to the contents management device 110, the detail of the change made to the associated data that has not been transferred to the contents management device 110 is transferred from the terminal device 100 to the contents management device 110, and the change is reflected in the second associated data.

First, an update history acquisition section 272 of the transfer control device 120 transmits a transfer command for transferring an update history of associated data to the terminal device 100 and the contents management device 110 (step S402).

At the terminal device 100 that has acquired the transfer command transmitted in the step S402, a first update history transmission section 206 transmits an update history of first associated data stored in the terminal device 100 to the transfer control device 120 (step S404).

At the contents management device 110 that has acquired the transfer command transmitted in the step S402, a second update history transmission section 256 transmits an update history of second associated data stored in the contents management device 110 to the transfer control device 120 (step S406). The update history acquisition section 272 of the transfer control device 120 acquires the update history of the first associated data transmitted in the step S404, and the update history of the second associated data transmitted in the step S406 (step S408).

Then, the judging section 274 of the transfer control device 120 compares the update history of the first associated data acquired in the step S408 with the update history of the second associated data acquired in the step S408, thereby judging as to whether or not the change made to the second associated data at the contents management device 110 has been transferred to and stored in the terminal device 100 (step S410).

In the step S410, if it is judged that the change made to the second associated data has been transferred to and stored in the terminal device 100 (step S410: Yes), the contents providing system 20 advances the processing to step S420.

On the other hand, in the step S410, if it is judged that the change made to the second associated data has not been stored in the terminal device 100 (step S410: No), the transfer control section 276 of the transfer control device 120 transmits, to the contents management device 110, a transfer command for transferring the detail of the change that is not stored in the terminal device 100 (step S412).

At the contents management device 110 that has acquired the transfer command in the step S412, the second transmission section 258 transmits, to the terminal device 100, the detail of the change that is not stored in the terminal device 100 (step S414).

At the terminal device 100, the first acquisition section 210 acquires the detail of the change transmitted in the step S414 (step S416). Then, the first automatic update section 212 reflects the detail of the change acquired in the step S416 in the first associated data, thereby updating the first associated data (step S418). Then, the contents providing system 20 advances the processing to the step S420.

In the step S420, the judging section 274 of the transfer control device 120 compares the update history of the first associated data acquired in the step S408 with the update history of the second associated data acquired in the step S408, thereby judging as to whether or not the change made to the first associated data at the terminal device 100 has been transferred to the contents management device 110 (step S420).

In the step S420, if it is judged that the change made to the first associated data has been transferred to and stored in the contents management device 110 (step S420: Yes), the contents providing system 20 ends a series of the processings shown in FIG. 6.

On the other hand, in the step S420, if it is judged that the change made to the first associated data has not been transferred to or stored in the contents management device 110 (step S420: No), the transfer control section 276 of the transfer control device 120 transmits, to the terminal device 100, a transfer command for transferring the detail of the change that has not been transferred to the contents management device 110 (step S422).

At the terminal device 100 that has acquired the transfer command in the step S422, the first transmission section 208 transmits, to the contents management device 110, the detail of the change that has not been transferred to the contents management device 110 (step S424).

At the contents management device 110, the second acquisition section 260 acquires the detail of the change transmitted in the step S424 (step S426). Then, the second automatic update section 262 reflects the detail of the change acquired in the step S426 in the second associated data, thereby updating the second associated data (step S428). Then, the contents providing system 20 ends a series of the processings shown in FIG. 6.

In accordance with the contents providing system 20 of the present embodiment, the first associated data and the second associated data can be mutually synchronized in a manner described above. Also, when associated data is updated at one of the terminal device 100 and the contents management device 110, the detail of the change made to the associated data is transferred to the other, but contents correlated to the associated data and the existing portion of the associated data are not transferred to the other. Therefore, the data amount of data transferred between the terminal device 100 and the contents management device 110 can be reduced. As a result, when the first associated data and the second associated data are mutually synchronized, the load placed on the communications network 130 can be reduced.

The contents providing system 20 may perform the processings shown in FIG. 6 upon detecting that associated data is updated at one of the terminal device 100 and the contents management device 110, or may periodically perform the processings shown in FIG. 6.

Alternatively, the contents providing system 20 may perform the processings shown in FIG. 6 at the timing when a specified event occurs. The specified event may be, for example, an event when the user of the terminal device 100 gives an instruction to do so, when the user of the terminal device 100 closes a file, when the user of the terminal device 100 logs out, and the like. Also, the processings shown in FIG. 6 may be performed, using a specified event occurring on the side of the contents management device 110 as a trigger. The specified event in this case may be, for example, an event when the user of the contents management device 110 gives an instruction to do so, when the user who is authorized to share associated data at the contents management device 110 logs in, and the like. Also, the processings shown in FIG. 6 may be performed, using a specified event occurring on the side of the transfer control device 120 as a trigger. The specified event in this case may be, for example, an event when the user of the transfer control device 120 gives an instruction to do so, when the user who is authorized to share associated data at the transfer control device 120 logs in, and the like. In addition, the contents providing system 20 may perform the processings shown in FIG. 6 at the timing when an addition, a change or a deletion is made to associated data for one of the terminal device 100 and the contents management device 110.

It is noted that, only when parameters such as the file name, the file type, the storage directory, the creation date and the like of contents correlated to second associated data having a change made thereto that is judged as not being stored in the terminal device 100 coincide with predetermined conditions, the contents providing system 20 may transfer the detail of the change made to the associated data from the contents management device 110 to the terminal device 100.

Similarly, only when parameters such as the file name, the file type, the storage directory, the creation date and the like of contents correlated to first associated data having a change made thereto that is judged as not being stored in the contents management device 110 coincide with predetermined conditions, the contents providing system 20 may transfer the detail of the change made to the associated data from the terminal device 100 to the contents management device 110.

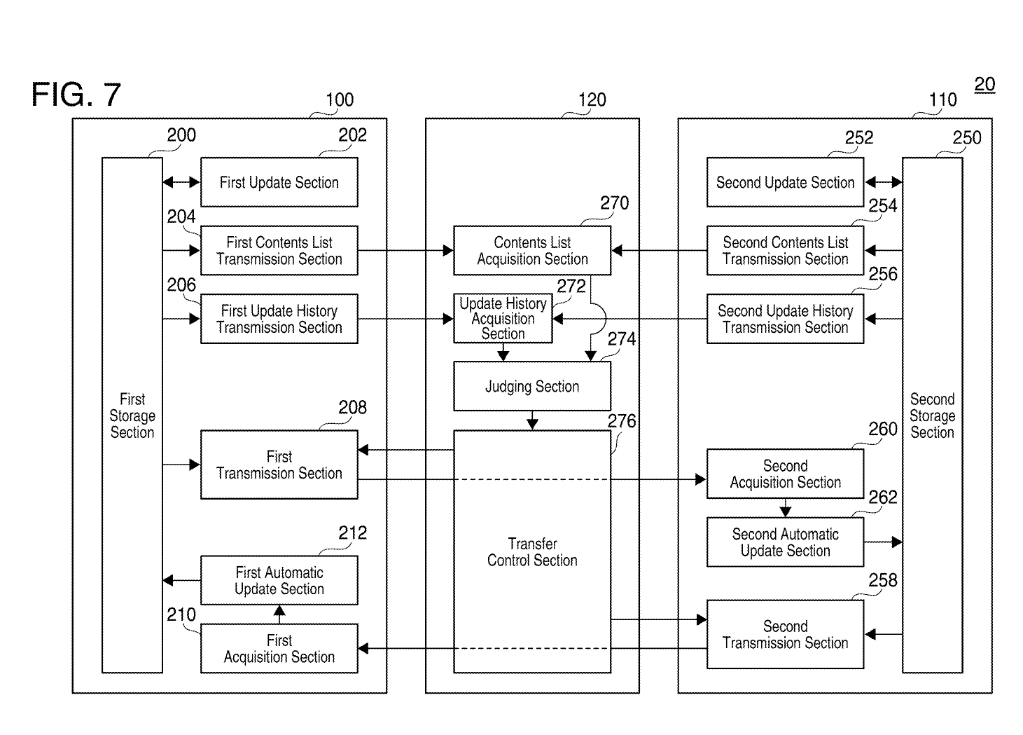

Next, referring to FIG. 7, the terminal device 100, functions of the contents management device 110 and the transfer control device 120 used for executing the processings described above are described in detail. It is noted that description of the functions that have been described above in the first embodiment may be omitted if appropriate.

FIG. 7 shows an example of a functional composition of the contents providing system 20. The terminal device 100 is equipped with a first storage section 200, a first update section 202, a first contents list transmission section 204, a first update history transmission section 206, a first transmission section 208, a first acquisition section 210, and a first automatic update section 212.

The first contents list transmission section 204 transmits a contents list of the terminal device 100. For example, the first contents list transmission section 204 retrieves a contents list of the terminal device 100 from the first storage section 200, and transmits the retrieved contents list of the terminal device 100 to the transfer control device 120.

The first update history transmission section 206 transmits update histories of associated data. For example, the first update history transmission section 206 retrieves an update history of associated data from the first storage section 200, and transmits the retrieved update history of the associated data to the transfer control device 120. The first update history transmission section 206 may transmit the updated update history of the associated data each time the first update section 202 updates the associated data, or may transmit a set of updated update histories of the associated data together, periodically or at the timing when a specified event occurs. Also, the first update history transmission section 206 may transmit an updated update history of the associated data upon receiving an instruction to do so from the user of the terminal device 100.

The first automatic update section 212 updates associated data stored in the first storage section 200. For example, the first automatic update section 212 adds, to the associated data stored in the first storage section 200 corresponding to contents, details of changes (additions, changes or deletions) made to the associated data of the contents of which the first acquisition section 210 has acquired from the contents management device 110, thereby updating the associated data stored in the first storage section 200.

The contents management device 110 is equipped with a second storage section 250, a second update section 252, a second contents list transmission section 254, a second update history transmission section 256, a second transmission section 258, a second acquisition section 260, and a second automatic update section 262.

The second update section 252 updates associated data stored in the second storage section 250. For example, the contents management device 110 displays a contents list of the contents management device 110 stored in the second storage section 250 on a display device, and accepts a selection operation to select a desired content provided by an input device. Then, the contents management device 110 retrieves the selected content from the second storage section 250, and displays the retrieved content on the display device. Then, the second update section 252 accepts a change operation to change associated data of the content provided by the input device. Further, the second update section 252 adds the accepted change provided by the input device to the associated data stored in the second storage section 250, thereby updating the associated data stored in the second storage section 250. Furthermore, the second update section 252 stores the update history of the updated associated data in the second storage section 250.

The second update history transmission section 256 transmits update histories of associated data. For example, the second update history transmission section 256 retrieves an update history of associated data from the second storage section 250, and transmits the retrieved update history of the associated data to the transfer control device 120. The second update history transmission section 256 may transmit the updated update history of the associated data each time the second update section 252 updates the associated data, or may transmit a set of updated update histories of the associated data together, periodically or at the timing when a specified event occurs. Also, the second update history transmission section 256 may transmit an updated update history of the associated data upon receiving an instruction to do so from the user of the contents management device 110.

The second transmission section 258 is capable of transmitting not only associated data but also details of changes (additions, changes, or deletions) made to the associated data. Changes made to associated data are recorded in an update history of the associated data. The second transmission section 258 can specify most recent changes added to the associated data by referring to the update history of the associated data stored in the second storage section 250. By setting flags on those of the changes that have already been transmitted to the terminal device 100, changes that have not been transmitted to the terminal device 100 can be readily identified. Then, the second transmission section 258 can transmit, to the terminal device 100, those of the changes recently made to the associated data that have not been transmitted to the terminal device 100.

The transfer control device 120 is equipped with a contents list acquisition section 270, an update history acquisition section 272, a judging section 274, and a transfer control section 276.

The contents list acquisition section 270 acquires contents lists. For example, the contents list acquisition section 270 transmits, to the terminal device 100, a transfer command to transfer a contents list of the terminal device 100 to the transfer control device 120. In response to the command, the terminal device 100 transmits the contents list of the terminal device 100 to the transfer control device 120, whereby the transfer control device 120 acquires the contents list of the terminal device 100. Also, the contents list acquisition section 270 transmits, to the contents management device 110, a transfer command for transferring a contents list of the contents management device 110 to the transfer control device 120. In response to the command, the contents management device 110 transmits the contents list of the contents management device 110 to the transfer control device 120, whereby the transfer control device 120 acquires the contents list of the contents management device 110.

The update history acquisition section 272 acquires update histories of associated data. For example, the update history acquisition section 272 transmits, to the terminal device 100, a transfer command for transferring an update history of associated data stored in the first storage section 200 of the terminal device 100 (hereafter referred to as first associated data) corresponding to contents to the transfer control device 120. Upon receiving the command, the terminal device 100 transmits the update history of the first associated data to the transfer control device 120. In this manner, the transfer control device 120 acquires the update history of the first associated data.

Also, the update history acquisition section 272 transmits, to the contents management device 110, a transfer command for transferring associated data stored in the second storage section 250 of the contents management device 110 (hereafter referred to as second associated data) corresponding to the contents to the transfer control device 120. Upon receiving the command, the contents management device 110 transmits the second associated data to the transfer control device 120. In this manner, the transfer control device 120 acquires the second associated data.

As described above, the first update history transmission section 206 can transmit the update history of the first associated data to the transfer control device 120 each time the first update section 202 updates the first associated data. In this case, in response to receiving the update history of the first associated data from the terminal device 100, the update history acquisition section 272 may acquire the second associated data stored in the contents management device 110.

Similarly, the second update history transmission section 256 may transmit the update history of the second associated data to the transfer control device 120 each time the second update section 252 updates the second associated data. In this case, in response to receiving the update history of the second associated data from the contents management device 110, the update history acquisition section 272 may acquire the first associated data stored in the terminal device 100.

The judging section 274 judges as to whether or not changes made to the first associated data at the terminal device 100 are stored in the contents management device 110. Also, the judging section 274 judges as to whether or not changes made to the second associated data at the contents management device 110 are stored in the terminal device 100. For example, by comparing the update history of the first associated data with the update history of the second associated data, the judging section 274 can judge as to whether or not changes made to the first associated data at the terminal device 100 are stored in the contents management device 110. Similarly, by comparing the update history of the first associated data with the update history of the second associated data, the judging section 274 can judge as to whether or not changes made to the second associated data at the contents management device 110 are stored in the terminal device 100.

The judging section 274 also judges as to whether or not contents stored in the terminal device 100 are stored in the contents management device 110. Also, the judging section 274 judges as to whether or not contents stored in the contents management device 110 are stored in the terminal device 100. For example, by comparing a contents list of the terminal device 100 acquired by the contents list acquisition section 270 with a contents list of the contents management device 110 acquired by the contents list acquisition section 270, the judging section 274 can judge as to whether or not the contents stored in the terminal device 100 are stored in the contents management device 110. Similarly, by comparing a contents list of the terminal device 100 acquired by the contents list acquisition section 270 with a contents list of the contents management device 110 acquired by the contents list acquisition section 270, the judging section 274 can judge as to whether or not the contents stored in the contents management device 110 are stored in the terminal device 100.

The transfer control section 276 controls transfer of contents and associated data between the terminal device 100 and the contents management device 110.

The transfer control section 276 controls transfer of, for example, contents between the terminal device 100 and the contents management device 110. When the judging section 274 judges that contents stored in the terminal device 100 are not stored in the contents management device 110, the transfer control section 276 has the terminal device 100 transmit the contents to the contents management device 110. Similarly, when the judging section 274 judges that contents stored in the contents management device 110 are not stored in the terminal device 100, the transfer control section 276 has the contents management device 110 transmit the contents to the terminal device 100.

For example, when the transfer control section 276 has the contents management device 110 transmit contents that are not stored in the terminal device 100 to the terminal device 100, the transfer control section 276 transmits, to the contents management device 110, a contents transfer command including identification information for identifying contents to be transmitted to the terminal device 100 and identification information for identifying the terminal device 100 that is the destination to which the contents are transmitted. Upon receiving the transfer command, the contents management device 110 transmits the contents that are not stored in the terminal device 100 to the terminal device 100. Similarly, when the transfer control section 276 has the terminal device 100 transmit contents that are not stored in the contents management device 110 to the contents management device 110, the transfer control section 276 transmits, to the terminal device 100, a contents transfer command including identification information for identifying contents to be transmitted to the contents management device 110 and identification information for identifying the contents management device 110 that is the destination to which the contents are transmitted. Upon receiving the transfer command, the terminal device 100 transmits the contents that are not stored in the contents management device 110 to the contents management device 110.

When associated data corresponding to a set of contents are stored in the contents management device 110 as second associated data, but not stored in the terminal device 100 as first associated data, the transfer control section 276 can have the contents management device 110 transmit the second associated data to the terminal device 100. In reverse, when associated data corresponding to a set of contents are stored in the terminal device 100 as first associated data, but not stored in the contents management device 110 as second associated data, the transfer control section 276 can have the terminal device 100 transmit the first associated data to the contents management device 110.

Furthermore, when the judging section 274 judges that changes made to the first associated data at the terminal device 100 are not stored in the contents management device 110, the transfer control section 276 has the terminal device 100 transmit details of the changes that are not stored in the contents management device 110 to the contents management device 110. Similarly, when the judging section 274 judges that changes made to the second associated data at the contents management device 110 are not stored in the terminal device 100, the transfer control section 276 has the contents management device 110 transfer details of the changes that are not stored in the terminal device 100 to the terminal device 100.

When the transfer control section 276 has the contents management device 110 transfer the details of the changes that are not stored in the terminal device 100 to the terminal device 100, the transfer control section 276 transmits, to the contents management device 110, a transfer command for transferring the details of the changes made to the associated data, including identification information for identifying the details of the changes made to the associated data to be transmitted to the terminal device 100, and identification information for identifying the terminal device 100 that is the destination to which the details of the changes made to the associated data are transmitted. Upon receiving the transfer command, the contents management device 110 transmits the details of the changes that are not stored in the terminal device 100 to the terminal device 100.

Similarly, when the transfer control section 276 has the terminal device 100 transfer the details of the changes that are not stored in the contents management device 110 to the contents management device 110, the transfer control section 276 transmits, to the terminal device 100, a transfer command for transferring the details of the changes made to the associated data, including identification information for identifying the details of the changes made to the associated data to be transmitted to the contents management device 110, and identification information for identifying the contents management device 110 that is the destination to which the details of the changes made to the associated data are transmitted. Upon receiving the transfer command, the terminal device 100 transmits the details of the changes that are not stored in the contents management device 110 to the contents management device 110.

In the example described above, the details of the changes made to the associated data are transferred between the terminal device 100 and the contents management device 110 without passing through the transfer control device 120. However, the transfer control device 120 may acquire, from the terminal device 100, the details of the changes made to the associated data transmitted from the terminal device 100, and may transfer the same to the contents management device 110. Similarly, the transfer control device 120 may acquire, from the contents management device 110, the details of the changes made to the associated data transmitted from the contents management device 110, and transfer the same to the terminal device 100.

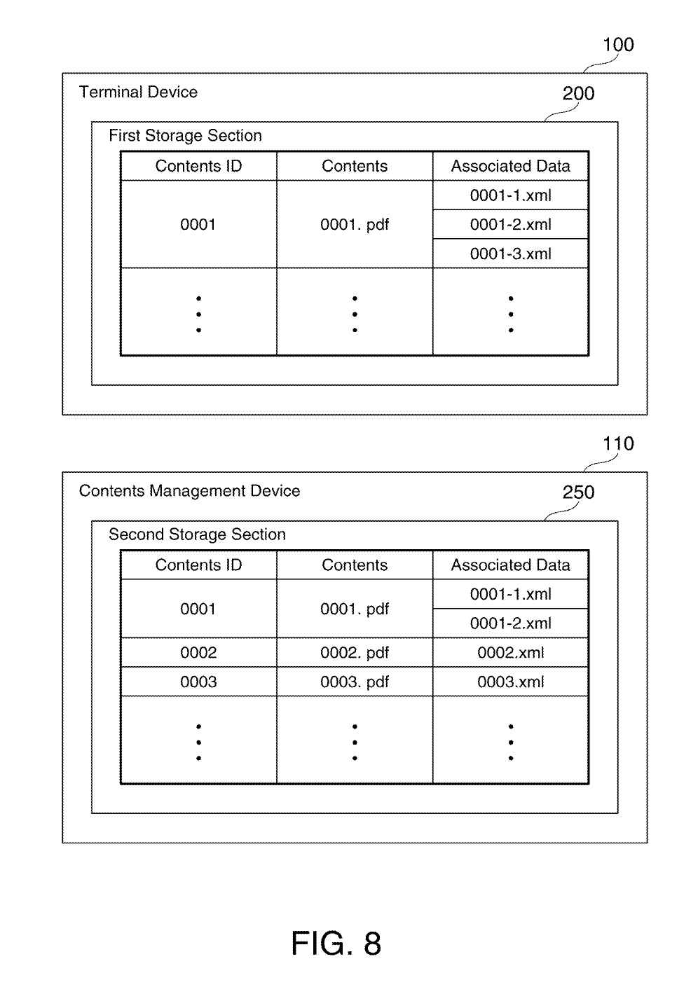

Next, referring to FIG. 8, mutual synchronization of the first associated data and the second associated data in accordance with the second embodiment is described. FIG. 8 shows an example of data stored in the contents management system 20. As shown in FIG. 8, the first storage section 200 of the terminal device 100 and the second storage section 250 of the contents management device 110 store contents respectively correlated to corresponding content IDs. Also, the first storage section 200 of the terminal device 100 and the second storage section 250 of the contents management device 110 store associated data of a single set or a plurality of sets, respectively correlated to each of the contents.

For example, the storage section 250 stores a content “0001.pdf,” a content “0002.pdf” and a content “0003.pdf.” On the other hand, the storage section 200 stores the content “0001.pdf.” The storage section 200 does not store the content “0002.pdf” or the content “0003.pdf.”

When the contents providing system 20 performs, for example, the processings shown in FIG. 5, contents that are stored in the contents management device 110 but not stored in the terminal device 100, i.e., the content “0002.pdf” and the content “0003.pdf” and associated data of these contents, i.e., a file “0002.xml” and a file “0003.xml” are transferred from the contents management device 110 to the terminal device 100. The terminal device 100 correlates the content “0002.pdf” with its associated data, the file “0002.xml” acquired from the contents management device 110, and stores them in the first storage section 200. Similarly, the terminal device 100 correlates the content “0003.pdf” with its associated data, the file “0003.xml” acquired from the contents management device 110, and stores them in the first storage section 200.

The first storage section 200 stores first associated data corresponding to the content “0001.pdf.” The first associated data includes a file “0001-1.xml,” a file “0001-2.xml” and a file “0001-3.xml.” On the other hand, the second storage section 250 stores second associated data corresponding to the content “0001.pdf.” The second associated data includes the file “0001-1.xml” and the file “0001-2.xml.” However, the file “0001-3.xml” is not included in the second associated data. In other words, the file “0001-3.xml” is a file that describes the detail of a change made to the first associated data at the terminal device 100, that has not been transferred to the contents management device 110, and that has not been reflected in the second associated data. By comparing the update history of the first associated data with the update history of the second associated data, it can be readily acknowledged that the file “0001-3.xml” is the file that describes the detail of the change made to the first associated data at the terminal device 100, that has not been transferred to the contents management device 110, and that has not been reflected in the second associated data.

Here, the file “0001-1.xml” records, for example, a comment for the content “0001.pdf” which has been inputted by the user of the terminal device 100 using an input device. The file “0001-2.xml” records, for example, a code written by the user using the input device in the content “0001.pdf” at an arbitrary location therein together with information for the location. The file “0001-3.xml” records a code written by the user using the input device in the content “0001.pdf” at another location therein together with information for the location.

As the contents providing system 20 performs the processings shown in FIG. 6, the file “0001-3.xml” that is not included in the second associated data is transferred from the terminal device 100 to the contents management device 110. At this time, the content “0001.pdf,” the file “0001-1.xml” and the file “0001-2.xml” are not transferred. The contents management device 110 correlates the file “0001-3.xml” transferred from the terminal device 100 with the content “0001.pdf,” and store the same in the second storage section 250. In this manner, the change made to the first associated data of the content “0001.pdf” at the terminal device 100 is reflected in the second associated data stored in the contents management device 110.

In this manner, according to the contents providing system 20 in accordance with the present embodiment, when associated data is updated in one of the terminal device 100 and the contents management device 110, the detail of the change made to the associated data is transferred to the other, but contents correlated to the associated data and the existing portion of the associated data are not transferred to the other. By this, the first associated data stored in the terminal device 100 and the second associated data stored in the contents management device 110 are automatically synchronized. Also, the data amount of data to be transferred between the terminal device 100 and the contents management device 110 can be reduced. As a result, when the first associated data and the second associated data are mutually synchronized, the load placed on the communications network 130 can be reduced.

The descriptions above pertain to the operations performed when comments and codes are added to the content “0001.pdf.” Next, operations to be performed when a portion of comments added in the past is deleted are described below.

In the case of deleting a portion of comments or the like, a file “0001-3.xml,” i.e., a file recording that the portion of the comments inputted in the past by the user of the terminal device 100 with respect to the content “0001.pdf” has been deleted by the user, is added. The file “0001-3.xml” is not included in the second associated data, and thus the file “0001-3.xml” has not been transferred to the contents management device 110, and the deletion of the part of the comments executed at the terminal device 100 has not been reflected in the second associated data. Accordingly, the contents providing system 20 performs the processings shown in FIG. 6, whereby the file “0001-3.xml” that is not included in the second associated data is transferred from the terminal device 100 to the contents management device 110. The contents management device 110 correlates the file “0001-3.xml” transferred from the terminal device 100 with the content “0001.pdf” and stores the same in the second storage section 250. In this manner, the change made to the first associated data of the content “0001.pdf” at the terminal device 100, in other words, the deletion of the part of the comments, is reflected in the second associated data stored in the contents management device 110.

According to the contents providing system 20 in accordance with the present embodiment, even when a portion of associated data is deleted at one of the terminal device 100 and the contents management device 110, the first associated data and the second associated data can be mutually synchronized. Also, the detail of the change made to the associated data is transferred to the other, but contents correlated to the associated data and the existing portion of the associated data are not transferred to the other, such that the data amount of data to be transferred between the terminal device 100 and the contents management device 110 can be reduced. As a result, when the first associated data and the second associated data are mutually synchronized, the load placed on the communications network 130 can be reduced.

According to the contents providing system 10 in accordance with the first embodiment, first associated data and second associated data are mutually synchronized by a method similar to the method used by the contents providing system 20. A major difference between the contents providing system 10 and the contents providing system 20 may reside in that whether or not the file “0001-3.xml” added at the terminal device 100 is transferred to the contents management device 110.

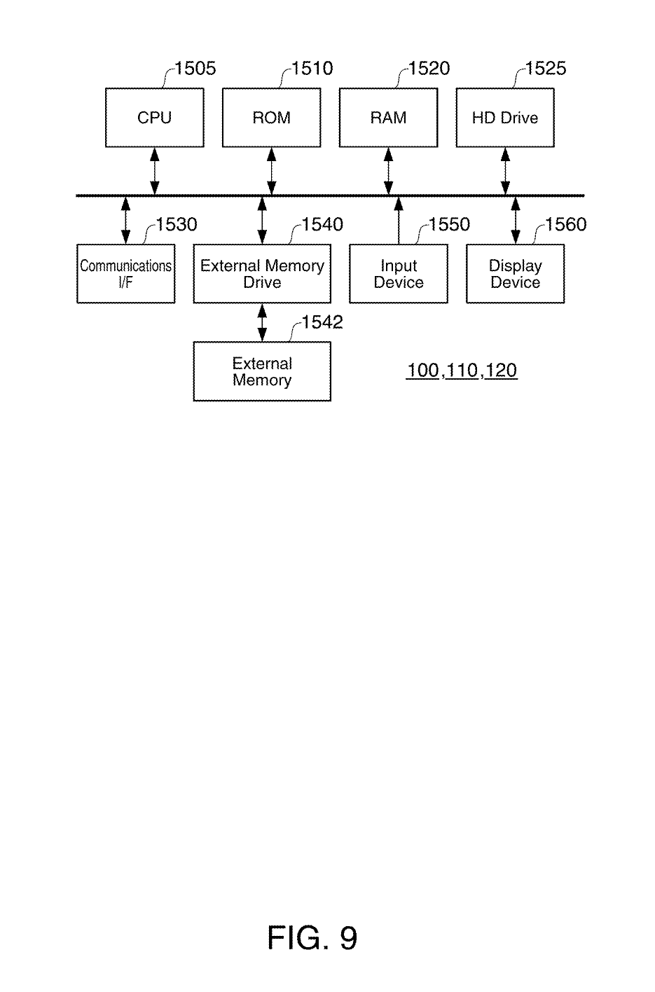

FIG. 9 shows an example of a hardware composition of the terminal device 100, the contents management device 110 and the transfer control device 120. The terminal device 100, the contents management device 110 and the transfer control device 120 are each equipped with a CPU 1505, a ROM 1510, a RAM 1520, a HD (hard disk) drive 1525, a communications interface 1530, an external memory drive 1540, an external memory 1542, an input device 1550, and a display device 1560. It is noted that the terminal device 100, the contents management device 110 and the transfer control device 120 may have mutually different hardware compositions. However, the present embodiment is described here, assuming that these devices have the same hardware composition.

The ROM 1510, the RAM 1520 and the HD drive 1525 store various kinds of data and various kinds of programs. At least one of the ROM 1510, the RAM 1520 and the HD drive 1525 of the terminal device 100 functions as the first storage section 200 described in conjunction with FIGS. 1 through 8. Also, at least one of the ROM 1510, the RAM 1520 and the HD drive 1525 of the contents management device 110 functions as the second storage section 250 described in conjunction with FIGS. 1 through 8.

The CPU 1505 executes the programs stored in the ROM 1510, the RAM 1520 or the HD drive 1525, thereby performing various kinds of data processing and various kinds of hardware controlling.

The communications interface 1530 connects to the communications network, and performs transmission and reception of data with respect to an external device through the communications network. The external memory drive 1540 connects to the external memory 1542, and performs transmission and reception of data with respect to the external memory 1542. As the external memory 1542, for example, a memory card may be used. The external memory 1542 may be a recording medium, such as, a flexible disk, a CD, a DVD and the like.

The display device 1560 displays various kinds of data. For example, the display device 1560 displays contents, associated data, contents lists, management screens for the aforementioned data. As the display device 1560, for example, a CRT display, a liquid crystal display, a plasma display, an organic EL display, an electronic paper or the like may be used. The input device 1550 inputs various kinds of operations. For example, the input device 1550 may input various operations, such as an operation to select contents, an operation to edit associated data, an operation to mange contents and the like. As the input device 1550, for example, a mouse, a keyboard, input bottoms, a touch panel and the like may be used.

At the terminal device 100, the programs executed by the CPU 1505 may render the computer to function as the first storage 200, the first update section 202, the first contents list transmission section 204, the first update history transmission section 206, the first transmission section 208, the first acquisition section 210, the first automatic update section 212, and the transfer control section 276 described above. The programs executed by the CPU 1505 at the terminal device 100 may be stored in advance in the memory medium of the terminal device 100 and supplied from there, or may be supplied externally to the terminal device 100 through the external memory 1542, or through the communications network.

Also, at the contents management device 110, the programs executed by the CPU 1505 may render the computer to function as the second storage section 250, the second update section 252, the second contents list transmission section 254, the second update history transmission section 256, the second transmission section 258, the second acquisition section 260, and the second automatic update section 262 described above. The programs executed by the CPU 1505 at the contents management device 110 may be stored in advance in the memory medium of the contents management device 110 and supplied from there, or externally supplied to the contents management device 110 through the external memory 1542 or through the communications network.

Further, at the transfer control device 120, the programs executed by the CPU 1505 may render the computer to function as the contents list acquisition section 270, the update history acquisition section 272, the judging section 274, and the transfer control section 276 described above. The programs executed by the CPU 1505 at the transfer control device 120 may be stored in advance in the memory medium of the transfer control device 120 and supplied from there, or externally supplied to the transfer control device 120 through the external memory 1542 or through the communications network.

It is noted that, at the terminal device 100, the ROM 1510, the RAM 1520, the HD drive 1525 or the external memory 1542 functions as the first storage section 200 described above. Also, at the contents management device 110, the ROM 1510, the RAM 1520, the HD drive 1525 or the external memory 1542 functions as the second storage section 250 described above.

### MODIFICATION EXAMPLE 1

According to the second embodiment described above, the contents providing system 10 includes the terminal devices 100, the contents management device 110 and the transfer control device 120. However, the invention is not limited to the composition described above. For example, at least one of the contents management device 110 and the terminal device 100 may concurrently function as the transfer control device 120. When the contents management device 110 concurrently functions as the transfer control device 120, the number of computers placed between the terminal device 100 and the contents management device 110 is reduced, such that data synchronization between the terminal device 100 and the contents management device 110 becomes faster.

When the terminal device 100 concurrently functions as the transfer control device 120, data synchronization between the terminal device 100 and the contents management device 110 not only becomes faster, but the load placed on the CPU 1505 provided in the contents management device 110 also becomes reduced, compared to the case where the contents management device 110 concurrently functions as the transfer control device 120, such that stressless contents management becomes possible.

Moreover, each of the contents management device 110 and the terminal device 100 may concurrently function as the transfer control device 120. In this case, even when a change is made to second associated data at the contents management device 110, or when a change is made to first associated data at the terminal device 100, it becomes easier to have the change made to the first associated data immediately reflected in the second associated data, or the change made to the second associated data immediately reflected in the first associated data, between the contents management device 110 and the terminal device 100.

### MODIFICATION EXAMPLE 2

In the second embodiment, the contents providing system is composed in such a manner that, when data such as contents are to be transferred from the terminal device 100 to the contents management device 110, the terminal device 100 transmits the data to the contents management device 110, and when data are to be transferred from the contents management device 110 to the terminal device 100, the contents management device 110 transmits the data to the terminal device 100. However, the invention is not limited to such a composition.

For example, the contents providing system may be composed in such a manner that, when data such as contents are to be transferred from the terminal device 100 to the contents management device 110, the terminal device 100 may transmit the data to the contents management device 110, and when data are to be transferred from the contents management device 110 to the terminal device 100, the terminal device 100 may retrieve contents or the like from the second storage section 250 provided in the contents management device 110. According to such a composition, the CPU 1505 provided in the terminal device 100 executes bidirectional data transmission between the terminal device 100 and the contents management device 110, such that the load placed on the CPU 1505 of the contents management device 110 is alleviated, and therefore stressless contents management becomes possible.

Also, the contents providing system may be composed in such a manner that, when data such as contents are to be transferred from the terminal device 100 to the contents management device 110, the contents management device 110 may retrieve contents or the like from the first storage section 200 provided in the terminal device 100, and when data are to be transferred from the contents management device 110 to the terminal device 100, the contents management device 110 may transmit the data to the terminal device 100. According to such a composition, the CPU 1505 provided in the contents management device 110 executes bidirectional data transmission between the terminal device 100 and the contents management device 110, such that the load placed on the CPU 1505 of the terminal device 100 is alleviated, and therefore stressless contents management becomes possible.

### MODIFICATION EXAMPLE 3

In the second embodiment described above, associated data are shared between one terminal device 100 and one contents management device 110. However, the invention is not limited to such a composition. For example, the invention is also applicable to a case where associated data are shared among a first terminal device 100, a second terminal device 100 and the contents management device 110.

When changes are made to associated data at the first terminal device 100, the second terminal device 100 may not necessarily be in a state communicable with the first terminal device 100. When the second terminal device 100 becomes communicable with the first terminal device 100, the judging section 274 of the transfer control device 120 may execute the processings shown in FIG. 6 between the first terminal device 100 and the second terminal device 100, such that those among the changes made to the associated data at the first terminal device 100 which have not been transferred to the second terminal device 100 may be transferred from the first terminal device 100 to the second terminal device 100. According to such a composition, associated data can be shared among the first terminal device 100, the second terminal device 100 and the contents management device 110, while the amount of data transferred between the first terminal device 100 and the second terminal device 100 can be suppressed to a small level.

The entire disclosure of Japanese Patent Application No. 2010-086470, filed Apr. 2, 2010 is expressly incorporated by reference herein.

What is claimed is:

1. A contents providing system that provides contents and associated data corresponding to the contents to a plurality of information processing devices, the contents providing system comprising:
a transfer control section that executes a control as to whether a change made to first associated data stored in a first information processing device corresponding to a set of contents is to be transferred from the first information processing device to a second information processing device that stores second associated data corresponding to the set of contents, the transfer control section executing the control when a specified event occurs.

2. A contents providing system according to claim 1, further comprising a judging section that executes a judgment as to whether or not the change has been transferred to the second information processing device,
the transfer control section executing the control so as to transfer the change when the judging section judges that the change has not been transferred to the second information processing device.

3. A contents providing system according to claim 1, wherein
the transfer control section executes the control so as to transfer the change when the set of contents satisfies a specified condition, and
the transfer control section executes the control so as not to transfer the change when the set of contents does not satisfy the specified condition.

4. An information processing device capable of communications with another information processing device and capable of storing contents and associated data corresponding to the contents, the information processing device comprising:
a transfer control section that executes a control as to whether a change made to first associated data stored in a first information processing device corresponding to a set of contents is to be transferred from the first information processing device to a second information processing device that stores second associated data corresponding to the set of contents,
the transfer control section executing the control when a specified event occurs.

5. A contents providing system according to claim 4, further comprising a judging section that executes a judgment as to whether or not the change has been transferred to the second information processing device,
the transfer control section executing the control so as to transfer the change, when the judging section judges that the change has not been transferred to the second information processing device.

6. A contents providing system according to claim 4, wherein
the transfer control section executes the control so as to transfer the change when the set of contents satisfies a specified condition, and
the transfer control section executes the control so as not to transfer the change when the set of contents does not satisfy the specified condition.

7. An information processing device capable of communications with another information processing device and capable of storing contents and associated data corresponding to the contents, the information processing device comprising:
an update section that makes a change to first associated data corresponding to a set of contents stored;
a transfer control section that controls transfer of the change to the other information processing device that stores second associated data corresponding to the set of contents; and
a transmission section that transmits the change to the other information processing device,
the transfer control section instructing the transmission section to transfer the change when a specified event occurs.

8. An information processing device according to claim 7, further comprising a judging section that executes a judgment as to whether or not the change has been transferred to the other information processing device,
the transfer control section instructing the transmission section to transfer the change, when the judging section judges that the change has not been transferred to the other information processing device.

9. An information processing device according to claim 7, wherein
the transfer control section instructs the transmission section to transfer the change when the set of contents satisfies a specified condition, and
the transfer control section does not instruct the transmission section to transfer the change when the set of contents does not satisfy the specified condition.
